(19) United States
(12) Patent Application Publication
(10) Pub. No.: US 2004/0161709 A1
(43) Pub. Date: Aug. 19, 2004

(54) Laser-written optical structures within calcium fluoride and other crystal materials

(76) Inventors: Joseph F. Schroeder, Lindley, NY (US); Alexander Streltsov, Painted Post, NY (US)

Correspondence Address: CORNING INCORPORATED, SP-TI-3-1, CORNING, NY, 14831

(21) Appl. No.: 10/361,946

(22) Filed: Feb. 10, 2003

(51) Int. Cl. G03H 1/04

(52) U.S. Cl. 430/321; 430/945; 430/1; 430/2; 359/9

(57) ABSTRACT

Diffractive optical structures are written within crystal optical elements using ultrafast near-infrared laser pulses. The crystal optical elements preferably perform an optical function such as focusing or chromatically dispersing light. The diffractive optical structures within the crystal optical elements perform additional optical functions that augment or refine the functions performed by the crystal optical elements.

### TECHNICAL FIELD

Laser pulses of femtosecond range duration focused within optical solids above a threshold power density induce localized changes in refractive index that can be traced by relative motion into diffractive optical structures. The invention is particularly concerned with writing diffractive structures within crystal materials such as calcium fluoride. Diffractive focusing structures so formed are useful for such purposes as correcting aberrations within crystal focusing optics, coupling waveguides within crystal substrates, and influencing spectral dispersion within crystal prisms.

### BACKGROUND

Waveguides and other related optical structures have been written inside bulk optical glass using writing beams containing high power pulses at wavelengths beyond the absorption edge of the optical glass. The writing beams operate at wavelengths at which the optical glass is substantially transparent so that the high power pulses can readily penetrate the glass. However, the high power pulses can be focused within the optical glass at power densities sufficient to induce localized changes in refractive index. Relative translations between the writing beams and the bulk optical glass trace waveguides or related structures within the optical glass.

For example, co-assigned U.S. patent application Ser. No. 09/627,868, entitled DIRECT WRITING OF OPTICAL DEVICES IN SILICA-BASED GLASS USING FEMTOSECOND PULSE LASERS, discloses methods for writing light-guiding structures in silica-based glass, particularly soft silica glass. A laser beam, such as produced by a Ti:Sapphire multi-pass amplifier, having a wavelength beyond the absorption edge of the soft silica glass [e.g., 400 nm to 1100 nm (nanometers)], a pulse duration of less than 200 fs (femtoseconds), a repetition rate of approximately 1 kHz to 250 kHz (kilohertz), and a pulse energy of approximately 0.1 μJ to 10 μJ (microjoules) is focused within the silica glass at a nominal power density from approximately 0.05×10¹⁵ W/cm² to 1×10¹⁵ W/cm² (watts per centimeter squared). Translation speeds of approximately 5 μm/s to 500 μm/s (microns per second) relatively advance a focal point of the laser beam along pathways inside the silica glass to write internal waveguides and other related structures such as couplers, interference devices, amplifiers, and activators.

Co-assigned U.S. patent application Ser. No. 09/628,666, entitled FEMTOSECOND LASER WRITING OF GLASS, INCLUDING BOROSILICATE, SULFIDE, AND LEAD GLASS, provides for writing similar optical structures within borosilicate, sulfide, and lead glasses. A laser beam, such as produced by a Ti:Sapphire mode-locked oscillator, having a similar wavelength and pulse duration as the preceding example but having a higher repetition rate of approximately 0.5 MHz to 100 MHz (megahertz) and a lower range of pulse energies of approximately 0.5 nJ to 10 nJ (nanojoules) can be used to write similar structures in the different glass materials. Beam intensity is preferably limited to between 10¹⁰ W/cm² and 10¹⁴ W/cm². Relative translations between the beam and the glasses can be used to produce various optical structures including Bragg and other types of waveguide modifying diffraction gratings.

### SUMMARY OF INVENTION

We have discovered that femtosecond laser pulses focused at or about a threshold intensity within the interiors of transmissive crystal materials induce localized changes in refractive index of sufficient magnitude to produce diffractive optical structures. Such crystal materials include calcium fluoride, crystal quartz, and to a lesser extent lithium niobate. The localized refractive index changes, which are believed to be the result of a non-linear absorption mechanism, convert areas of the crystal materials under focus into a less organized state having a reduced index of refraction. Relative motion between the pulses and the crystal materials can be used to trace arrays of tracks within the interiors of the crystal materials capable of performing diffractive optical functions.

An exemplary method of writing a diffractive optical structure within a crystal optical element in accordance with our invention includes producing a writing beam composed of a succession of pulses having a pulse duration less than 200 femtoseconds and a wavelength beyond an absorption edge (optical density of unity) of the crystal optical element. The writing beam is focused beneath a surface of the crystal optical element at a power density sufficient to induce a localized change in refractive index within an interior of the crystal optical element. A pattern of relative motion between the writing beam and the crystal optical element traces an array of tracks within the crystal optical element for performing a diffractive optical function.

The writing beam is preferably focused at a power density sufficient to induce a localized decrease in refractive index of the crystal optical element. The refractive index decrease is preferably -at least 1.0×10⁻² at the intended nominal operating wavelength of the crystal element. For crystal optical elements made of calcium fluoride, the pulse energy of the succession of pulses is preferably within a range between 0.1 μJ to 20 μJ (microjoules). For crystal optical element made of crystal quartz, the pulse energy of the succession of pulses is at least 0.2 μJ.

Preferably, the crystal optical element performs a non-diffractive optical function that is compatible with the diffractive function of the array of tracks within the crystal optical element. For example, the crystal optical element can be arranged to perform a refractive focusing function such as by fashioning the surface of the crystal optical element in a spherical or aspherical form. The array of tracks within the crystal optical element can be arranged to perform a diffractive focusing function producing a chromatic dispersion that at least partially compensates for a chromatic dispersion otherwise exhibited by the refractive focusing function of the crystal optical element. Such compensations are particularly useful for correcting below 200 nanometer wavelength transmitting crystals, where choices for making chromatic corrections are more limited.

The array of tracks can also be arranged to compensate for geometric aberrations of the crystal optical element. The relative motions for writing the array of tracks can be imparted in all three orthogonal directions to produce three dimensionally structured gratings. As such, the gratings can be tilted or blazed or given higher order attributes for reshaping diffracted wavefronts. Compound gratings can also be written at different levels within the crystal element.

Instead of performing a refractive focusing function, the crystal optical element could be arranged to perform a refractive chromatic dispersing function that is augmented or further refined by a diffractive chromatic dispersing function of the array of tracks. The refractive chromatic dispersing function can be achieved by shaping the crystal optical element as a prism. The augmentation or refinement of this function can be achieved by writing one or more arrays of tracks in the form of diffraction gratings along optical pathways within the prism. For example, one grating can be written adjacent to a first surface of the prism and a second grating can be written adjacent to a second surface of the prism.

Incorporation of diffractive optics within the interiors of the crystal optical elements leaves the surfaces of the crystal optical elements unobstructed for receiving treatments or cleaning. For example, the optical surfaces of the crystal optical elements can be treated with coatings, such as reflective, anti-reflective, beamsplitter, filter, and protective coatings, that are undisturbed by the incorporation of interior diffractive optics.

The crystal optical element could also be arranged to provide interior waveguiding properties, and the array of tracks could be arranged to perform a diffractive coupling function for coupling light to or from an interior waveguide. Both the interior waveguide and the array of tracks could be formed by the same or similar writing beams focused at power densities sufficient to induce a localized decrease in refractive index of the crystal optical element. For example, the same or similar writing beams could be arranged to trace both a cladding portion of the waveguide and an array of tracks along a length of the waveguide having a period set to couple wavelengths into or out of the waveguide.

An exemplary compound optic formed in accordance with our invention features a diffractive optic formed within a crystal element that performs a separate non-diffractive optical function. The crystal optical element includes an interior bounded in part by an optical surface. An array of laser-written tracks are written beneath the optical surface within the interior of the crystal optical element. The array of laser-written tracks perform a diffractive optical function compatible with the non-diffractive optical function of the crystal optical element.

The laser-written tracks locally transform interior portions of the crystal optical element into a different state that exhibits a refractive index different from a surrounding refractive index of the crystal optical element. Both the crystal optical element itself and the array of laser-written tracks within it are preferably optically aligned along a common optical axis for jointly contributing to the management of light transmitted through the crystal optical element.

The crystal optical element can be arranged to perform a variety of non-diffractive optical functions including a refractive focusing function and a refractive chromatic dispersing function. For performing the refractive focusing function, the optical surface of the crystal optical element preferably has a spherical or aspherical form. For performing the refractive chromatic dispersing function, the crystal optical element is preferably shaped in the form of a prism.

The array of tracks written within the crystal optical element can also be arranged to perform a variety of functions including correcting chromatic or geometric aberrations associated with the refractive focusing function of the crystal optical element. In this regard, the array of tracks can be written in a nominally concentric form having a progressive variation in pitch for performing a diffractive focusing function. Intentional chromatic dispersion of the crystal optical element can be augmented or refined by other arrangements of the array of tracks.

The crystal optical element can also provide an optical medium for writing one or more interior waveguides using a similar writing beam. The array of tracks, which can be written by the same or a similar beam, can provide for modifying the waveguiding properties of the interior waveguides. For example, the array of laser-written tracks can be arranged for performing a coupling function to, from, or between the waveguides.

### DRAWINGS

FIG. 1 is a diagram of a representative writing system for writing diffractive optical structures inside crystal optical elements.

FIG. 2 is an axial view of a crystal lens within which a diffractive optical structure is written in the form of concentric rings.

FIG. 3 is a photograph taken through a 20× (power) objective using 633 nm light of a diffractive optical structure written into a calcium fluoride plate.

FIG. 4 is a similarly taken photograph of a focus produced by the diffractive optical structure of FIG. 3.

FIG. 5 is another photograph of a mask imaged by the diffractive optical structure of FIG. 3.

FIG. 6 is a perspective view of a crystal prism within which diffractive optical structures are writing in the form of linear gratings.

FIG. 7 is a side view of the crystal prism showing a combined spectral dispersing function performed by the prism and the linear gratings within the prism.

### DETAILED DESCRIPTION

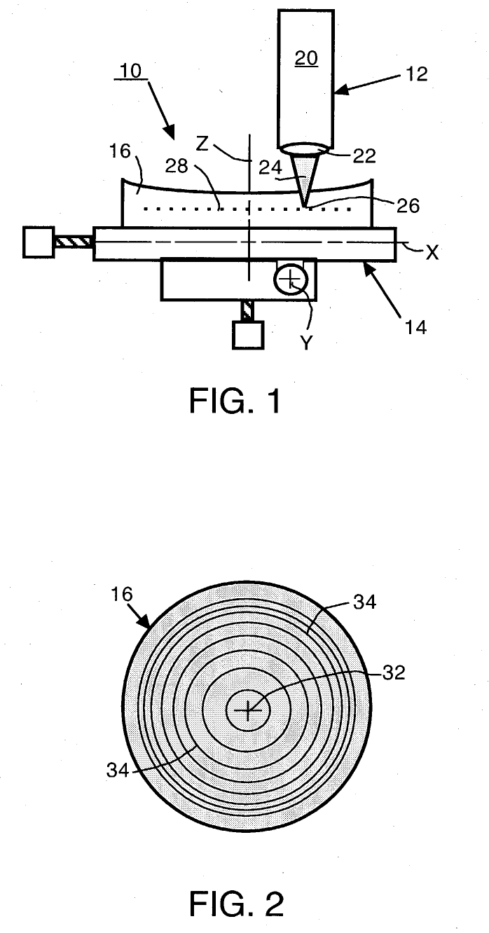

Referring to FIG. 1, an exemplary writing system 10 for writing diffractive optical structures within the interiors of crystal materials includes a laser writing tool 12 and a conventional computer-controlled multi-axis stage assembly 14 supporting a crystal lens 16. The stage assembly 14 provides for translating the crystal lens 16 in three orthogonal directions X, Y, and Z with respect to the writing tool 12. One or more of the translational motions could be applied instead to the writing tool 12 to support similar relative motions. Relative angular motions could also be used to change the angular orientation of the writing tool 12 with respect to the crystal lens 16.

The writing tool 12 includes an ultrafast near-infrared laser 20 and focusing optics 22 for producing a writing beam 24 that converges to a focus 26 within the crystal lens 16. The laser 20 is preferably a Ti:Sapphire multi-pass amplifier laser having a pulse duration less than 200 fs (femtoseconds), preferably less than 100 fs, and having a wavelength beyond an absorption edge of the crystal lens 16. In other words, the wavelength is chosen within a range of wavelengths at which the crystal lens 16 is transmissive. However, the focusing optics 22 converge the writing beam 24 to the focus 26 at a power density sufficient to produce a localized reduction in the refractive index of the crystal lens 16.

Preferably, the focusing optics 22 converge the writing beam 24 to the focus 26 within the lens 16 having a spot size near the diffraction limit (e.g., approximately 3 microns to 5 microns) to concentrate pulse energies (e.g., 0.1 μJ to 20 μJ) to appropriate power densities. Numerical apertures above 0.2 are generally preferred to limit a depth of focus at which the beam 24 is effective for producing a localized change in the refractive index. However, a tradeoff is involved. Increases in numerical aperture also have the effect of decreasing working distance, which can limit the depth at which an array of tracks 28 or other features can be written into the crystal lens 16.

The exposure wavelength should be greater than the absorption edge of the crystal material of the lens 16 to support uninhibited transmissions of the beam 24 through the interior of the lens 16. However, the exposure wavelength is preferably within a multiple of two times the absorption edge to limit the amount of energy needed to induce a refractive index decrease in the crystal material of the lens 16. Beyond the absorption edge, the absorption coefficient tends to decrease exponentially with wavelength.

Pulse duration (width) should be as short as possible to achieve the highest intensities with the least amount of pulse energy. The femtosecond pulses are preferably less than 200 femtoseconds in duration, but pulses as short as 20 femtoseconds are favored to achieve the desired intensity with limited pulse energy. Pulses much below 20 femtoseconds are known to disperse through both air and glass. Pulse widths within a 20 femtosecond to 50 femtosecond range are considered practical for most applications.

Refractive index decreases produced by the writing beam 24 in the crystal material of the lens 16 are substantially greater than those that can be similarly produced in amorphous materials such as glass. The larger decreases in refractive index are typically in the vicinity of 1.5×10⁻². Single-axis crystals of calcium fluoride can absorb the shock of the concentrated energy transfers from the writing beam 24 leaving precisely defined regions (e.g., the array of tracks 28) of reduced refractive index. Other examples of such single-axis-crystal materials are lithium nobate and crystal quartz.

Additional details of writing systems capable of writing tracks within crystal optical elements are disclosed in co-assigned U.S. application Ser. No. 10/147,698, entitled LASER-WRITTEN CLADDING FOR WAVEGUIDE FORMATIONS IN GLASS, which is hereby incorporated by reference.

FIG. 2 depicts the crystal lens 16 along its optical axis 32 arranged as a compound optic with the array of tracks 28 written in concentric rings 34 of progressively varying density for performing a diffractive focusing function. Thus, in addition to exhibiting a primary refractive focusing function as a result of its surface geometry, the crystal lens 16 as a compound optic also exhibits a secondary diffractive focusing function as a result of the concentric rings 34 written into its interior. Preferably, the secondary diffractive focusing function provides for further refining or augmenting the primary refractive focusing function, such as by correcting geometric or chromatic aberrations within the crystal lens 16 itself or within a larger optical grouping. Such diffractive optical structures are particularly well suited for reducing chromatic dispersion.

The multi-axis stage assembly 14 can support relative motion between the writing beam 24 and the crystal lens 16 to trace the tracks 28 along three-dimensional curvilinear paths. The tracks 28 can be written with curvilinear paths that depart from circles, such as oval, eccentric, or other closed-shaped paths, to make a wider range of geometric corrections. In addition, the tracks can be written or offset through different levels within the crystal optical element (e.g., at different positions along the Z axis) for such purposes as tilting, blazing, or other higher order attributes for reshaping diffracted wavefronts. Depth variations can be made to arrange the tracks 28 parallel with a working surface 30 of the crystal optical element. Multiple or compound gratings can be written on different levels for further refining the geometric and chromatic effects.

For producing a conventional diffractive focusing function, the concentric rings are preferably arranged on radii Rₘ in accordance the following equation:

Rₘ=\sqrt{λFₘ}

where λ is the intended wavelength for transmission, F is a focal distance, and m is the ring number. The arrangement provides for diffracted beams from neighboring rings to interfere constructively at the focus. Although most of the power is concentrated at one focus, multiple foci are possible corresponding to the orders of diffraction.

The thickness of the rings 34 as a percentage of their period affects how light is distributed between positive and negative orders of diffraction. For purposes of concentrating light at a focus, the rings 34 are preferably as thin as possible in relation to their period to favor the same sign orders of diffraction. Chromatic dispersion is known to be a function of focal length with wavelength dispersion increasing as a function of decreasing pitch.

The array of tracks 28 in the form of concentric rings 34 or other shapes can be written to a line width resolution approaching the wavelength of the writing beam 24. For example, line widths as small as 1 micron (1000 nm) are possible at wavelengths of 800 nm. Minimizing power and maximizing in scan rate (i.e., the rate of relative motion between the writing beam 24 and the crystal lens 1 6) provide for minimizing the line width of the tracks 28.

To perform the desired diffractive focusing function that is compatible with (e.g., augments, corrects, or further refines) the refractive focusing function of the lens 16, the concentric rings 34 are generally centered about the optical axis 32 and occupy one or more transverse planes (e.g., the plane of FIG. 2) of the lens 16. Both the refractive optical structure of the lens 16 and the diffractive optical structure of the concentric rings 34 bend light in axial planes of the optical axis 32.

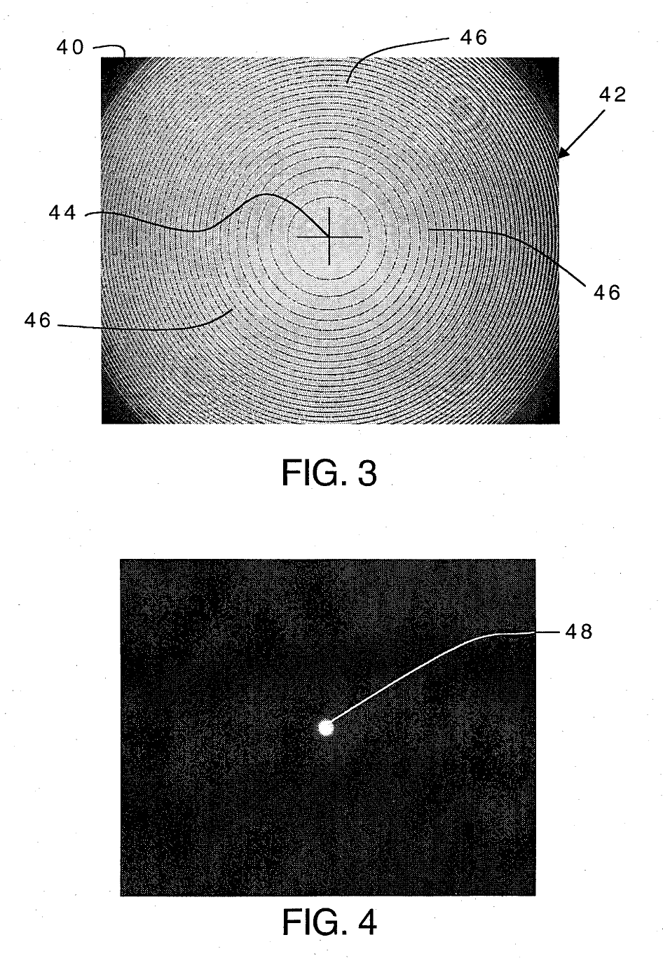

A diffractive focusing optic 42 as shown in the photograph of FIG. 3 is written into a crystal element 40 of calcium fluoride fashioned as a flat plate for isolating diffractive focusing effects. The writing beam 24 (see FIG. 1) produced by a Ti:Sapphire multi-pass amplifier laser has a wavelength of 800 nm and is divided into succession of pulses having pulse width of 40 fs and a repetition rate of 20 kHz. Each pulse has a pulse energy of 250 nJ (nanojoules). The writing beam 24 is focused approximately 100 Am (micrometers) below a front surface of the calcium fluoride plate 40 by a 20×/O.5 NA (power/numerical aperture) aspheric focusing lens (e.g., from New Focus, Inc., San Jose, Calif.) located 100 um from the front surface of the plate 40.

The multi-axis stage assembly 14 relatively moves calcium fluoride plate 40 with respect to the writing beam 24 in concentric circles about an optical axis 44 at a speed of 0.2 mm/s (millimeters per second), tracing 60 concentric rings 46 up to a maximum diameter of approximately 1.2 mm (millimeters). The rings 46, which measure approximately 1 micron in width, are spaced so that the resulting diffractive focusing optic 42 has a focal distance of 5 mm at 633 nm wavelength.

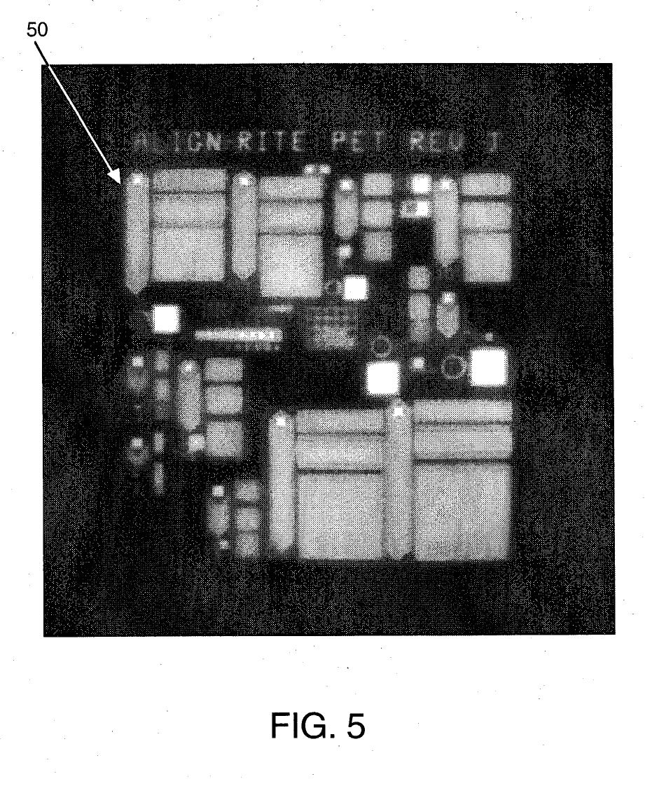

A photograph of a focus 48 produced by the diffractive focusing optic 42 is shown in FIG. 4. FIG. 5 depicts a mask 50 imaged by the same 20× power lens and demonstrating imaging capabilities of the diffractive focusing optic 42.

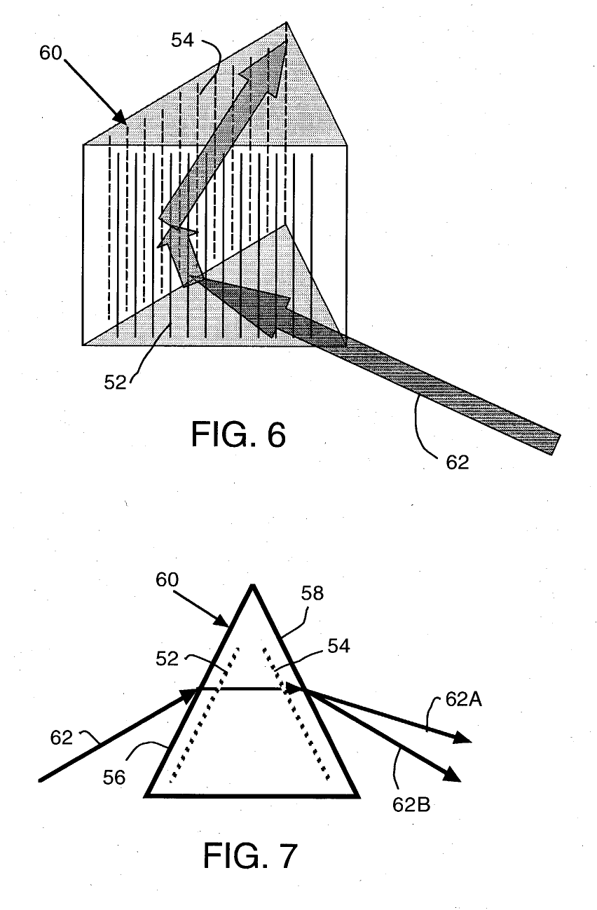

As shown in FIGS. 6 and 7, alternative diffractive optical structures in the form of linear gratings 52 and 54 are written beneath two side surfaces 56 and 58 of a prism 60 in FIG. 6. The prism 60 is preferably composed of a transmissive single-axis-crystal material, such as calcium fluoride, lithium nobate, or quartz crystal. Each of the linear gratings 52 and 54 is formed by an array of parallel tracks written into the prism 60 by a writing system similar to the exemplary writing system 10 of FIG. 1.

The crystal prism 60 performs a refractive chromatic dispersing function for angularly separating different wavelength portions 62A and 62B of a beam 62. Although the beam 62 is depicted in FIG. 7 as being separated into just two different wavelength portions 62A and 62B, the chromatic dispersing function of the crystal prism 60 provides for progressively angularly separating a full range of wavelengths within the beam 62. The chromatic dispersing function of the prism is augmented or refined by a complementary diffractive chromatic dispersing function of the linear gratings 52 and 54 that are written beneath the side surfaces 56 and 58 of the prism 60 along a pathway of the beam 62 through the prism 60.

The linear gratings 52 and 54 preferably extend in directions traverse to the intended direction of propagation of the beam 62 through the crystal prism 60. However, the gratings 52 and 54 can be inclined to the direction of beam propagation or occupy varying depths for further shaping the spectral response. In addition, alternative diffractive optical structures can be written into the crystal prism 60 with curvilinear or other shaped tracks to provide geometric as well as spectral effects on the beam 62. These effects are particularly useful in below 200 nanometer wavelength transmitting crystals, where corrections between crystals can be more, limited.

In the examples of compound optics given thus far, the optical functions performed by the crystal optical elements and the diffractive optical structures written within them are largely the same. For example, the refractive focusing function of the crystal lens 16 is complemented by the diffractive focusing function of the concentric rings 34 written within the crystal lens 16, and the refractive chromatic dispersing function of the crystal prism is complemented by the diffractive chromatic dispersing function of the linear gratings 52 and 54 that are written within the crystal prism. However, the diffractive optical structures written inside the crystal optical elements can also perform compatible functions that differ from the primary optical function of the crystal optical elements. For example, focusing and dispersing functions can be mixed.

More than one diffractive optical structure can be written into crystal materials to provide multiple compatible optical functions. For example, multiple arrays of tracks can be written within the crystal optical elements for performing compound diffractive functions. The tracks can also be arranged to perform a blazing function for influencing the distribution of diffracted light among a plurality of diffractive orders.

Incorporating diffractive optical structures inside crystal elements leaves the surfaces of the crystal elements free to receive other treatments or operations. For example, optical surfaces of the crystal elements can be cleaned or polished without altering or damaging the underlying diffractive optical structures. In addition, thin-film coatings and other treatments can be applied to the optical surfaces for other optical purposes (e.g., filtering, reflecting, or anti-reflecting) that would not be possible if the surfaces were otherwise interrupted by diffractive optical structures.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

We claim:

1. A compound optic of a crystal material for performing a plurality of compatible optical functions comprising:
a crystal optical element that performs a non-diffractive optical function, the crystal optical element including an interior bounded in part by an optical surface;
an array of laser-written tracks written beneath the optical surface within the interior of the crystal optical element; and
the array of laser-written tracks being arranged to perform a diffractive optical function compatible with the non-diffractive optical function of the crystal optical element.

2. The compound optic of claim 1 in which the laser-written tracks locally transform interior portions of the crystal optical element into a different state that exhibits a refractive index different from a surrounding refractive index of the crystal optical element.

3. The compound optic of claim 2 in which laser-written tracks induce a localized decrease in refractive index of the crystal optical element.

4. The compound optic of claim 1 in which the array of laser-written tracks is optically aligned with the crystal optical element along a common optical axis.

5. The compound optic of claim 4 in which the crystal optical element is arranged to perform a refractive focusing function.

6. The compound optic of claim 5 in which the optical surface of the crystal optical element has a non-planar form for performing the refractive focusing function.

7. The compound optic of claim 4 in which the array of laser written tracks is arranged concentric to the common optical axis and has a progressive variation in pitch for performing a diffractive focusing function on light propagating along the common optical axis.

8. The compound optic of claim 7 in which the non-diffractive optical function of the crystal optical element is a refractive focusing function.

9. The compound optic of claim 8 in which both the non-diffractive optic and the diffractive optic bend light in axial planes of the optical axis.

10. The compound optic of claim 7 in which the diffractive optical function of the array of tracks within the crystal optical element reduces optical aberrations otherwise exhibited by the refractive focusing function of the crystal optical element.

11. The compound optic of claim 7 in which the diffractive optical function of the array of tracks produces a chromatic dispersion that at least partially compensates for a chromatic dispersion otherwise exhibited by the refractive focusing function of the crystal optical element.

12. The compound optic of claim 1 in which the crystal optical element is arranged in the form of a prism.

13. The compound optic of claim 12 in which the prism is arranged to perform a function of chromatic dispersion and the array of laser-written tracks is arranged to influence the chromatic dispersion function of the prism.

14. The compound optic of claim 13 in which the array of laser-written tracks is a first of a pair of arrays of laser-written tracks for further chromatically dispersing light within the prism.

15. The compound optic of claim 1 in which the crystal optical element is made of a single-axis-crystal material.

16. The compound optic of claim 15 in which the crystal optical element is made of calcium fluoride.

17. The compound optic of claim 15 in which the crystal optical element is made of crystal quartz.

18. The compound optic of claim 1 in which the tracks have a width of less than 5 microns.

19. A method of writing a diffractive optical structure within an optical element formed from a crystal comprising the steps of:
producing a writing beam composed of a succession of pulses having a pulse duration less than 200 femtoseconds and a wavelength beyond an absorption edge of the crystal optical element;
focusing the writing beam beneath a surface of the crystal optical element at a power density sufficient to induce a localized change in refractive index within an interior of the crystal optical element; and
relatively moving the writing beam and the crystal optical element to trace an array of tracks within the crystal optical element arranged for performing a diffractive optical function.

20. The method of claim 19 in which the writing beam is focused at a power density sufficient to induce a localized decrease in refractive index of the crystal optical element.

21. The method of claim 20 in which the refractive index decrease is at least 1.0×10⁻² at the intended nominal operating wavelength of the crystal element.

22. The method of claim 19 in which the crystal optical element is made of a single-axis-crystal material.

23. The method of claim 22 in which the crystal optical element is made of calcium fluoride.

24. The method of claim 23 in which pulse energy of the succession of pulses is at least 0.2 microjoules.

25. The method of claim 22 in which the crystal optical element is made of crystal quartz.

26. The method of claim 25 in which pulse energy of the succession of pulses is at least 0.5 microjoules.

27. The method of claim 19 including an additional step of arranging the crystal optical element to perform a non-diffractive optical function that is compatible with the diffractive function of the array of tracks within the crystal optical element.

28. The method of claim 27 in which the crystal optical element is arranged to perform a refractive focusing function.

29. The method of claim 28 in which the step of arranging includes arranging the surface of the crystal optical element in a non-planar form for performing the refractive focusing function.

30. The method of claim 28 in which the step of relatively moving the writing beam includes relatively moving the writing beam to trace an array of concentric tracks for performing a diffractive focusing function.

31. The method of claim 30 in which the diffractive optical function of the array of tracks within the crystal optical element reduces optical aberrations otherwise exhibited by the refractive focusing function of the crystal optical element.

32. The method of claim 31 in which the diffractive optical function of the array of tracks produces a chromatic dispersion that at least partially compensates for a chromatic dispersion otherwise exhibited by the refractive focusing function of the crystal optical element.

33. The method of claim 27 in which the crystal optical element is arranged in the form of a prism for performing a chromatic dispersing function.

34. The method of claim 33 in which the array of tracks is arranged to perform a chromatic dispersing function that complements the chromatic dispersing function of the prism.

35. The method of claim 33 in which the step of relatively moving the writing beam includes tracing multiple arrays of tracks within the crystal optical element for performing a diffractive dispersing function that complements the chromatic dispersing function of the prism.

36. The method of claim 19 in which the step of relatively moving includes tracing tracks that are relatively offset with respect to each other in a direction of an optical axis of the crystal optical element.

37. The method of claim 36 in which the tracks are arranged to perform a blazing function for influencing the distribution of diffracted light among a plurality of diffractive orders.

38. The method of claim 19 in which the step of relatively moving includes tracing a first set of tracks for performing a first diffractive optical function and tracing a second set of tracks for performing a second diffractive optical function.

39. The method of claim 38 in which the first and second diffractive optical functions cooperate to perform a compound diffractive optical function.

40. An optical device containing a diffractive optical structure written within its interior for reshaping a wavefront passing through the device comprising:
a crystal optical element having an interior, an optical surface partly bounding the interior, and a reference axis passing through both the optical surface and the interior;
an array of tracks written beneath the optical surface within the interior of the crystal optical element being distinguished from a remaining portion of the interior of the crystal optical element by a reduced refractive index; and
the array of tracks being arranged to diffract light passing through the crystal optical element with respect to the reference axis for reshaping a wavefront of the light passing through the crystal element.

41. The device of claim 40 in which the array of tracks extend within one or more planes oriented traverse to the reference axis.

42. The device of claim 41 in which the array of tracks are arranged to diffract light toward the reference axis for performing a diffractive focusing function.

43. The device of claim 42 in which the optical surface of the crystal optical element has a non-planar form for performing a refractive focusing function.

44. The device of claim 43 in which both the optical surface and the array of tracks bend light in common axial planes of the reference axis.

45. The device of claim 43 in which the diffractive optical function of the array of tracks within the crystal optical element reduces optical aberrations otherwise exhibited by the refractive focusing function of the crystal optical element.

46. The device of claim 40 in which the crystal optical element is arranged in the form of a prism.

47. The device of claim 46 in which the prism is arranged to perform a function of chromatic dispersion and the array of tracks is arranged to influence the chromatic dispersion function of the prism.

48. The device of claim 47 in which the array of tracks is a first of a pair of arrays of tracks for further chromatically dispersing light within the prism.

49. The device of claim 40 in which the refractive index decrease is at least 1.0×10⁻² at the intended nominal operating wavelength of the device.

50. The device of claim 40 in which the crystal optical element is made of a below 200 nanometer transmitting crystal material.

51. The device of claim 50 in which the crystal optical element is made of calcium fluoride.
